(19) United States
(12) Patent Application Publication
(10) Pub. No.: US 2020/0231472 A1
(43) Pub. Date: Jul. 23, 2020

(54) Pool Water Disinfection

(71) Applicant: BioCool AB, Skellefteå (SE)

(72) Inventor: JanOlof Eriksson, Skellefteå (SE)

(21) Appl. No.: 16/485,953

(22) PCT Filed: Feb. 5, 2018
(86) PCT No.: PCT/SE2018/050094

§ 371 Date: Aug. 14, 2019

(30) Foreign Application Priority Data
Feb. 17, 2017 (SE) 1750160-2

(51) Int. Cl. C02F 1/50; C02F 1/76

(52) U.S. Cl. CPC C02F 1/50; C02F 2103/42; C02F 1/76

(57) ABSTRACT

The present invention provides for a composition for disinfecting water in pools or recreational water systems, containing didecyldimethylammonium chloride (DDAC) as a single effective agent in disinfecting water from all microorganisms, including bacteria, virus, amoebae, fungi and algae, as well as use thereof for disinfecting pool water and a method for disinfection of pool water.

### TECHNICAL FIELD

The present invention relates to disinfection of water in pools and recreational water systems. It relates to a composition for use in disinfection of water, as well as a method for disinfection of water in pools and recreational water systems.

### BACKGROUND ART

Sanitization of water in swimming pools and other recreational water systems, such as Jacuzzis and bubble pools, is an important aspect of maintenance in order to keep the amount of microorganisms in the water below a threshold level, which is typically about 100 CFU/ml (CFU=Colony Forming Units). The microorganisms that need to be managed are for instance bacteria, viruses, amoebae, algae and fungi. A too high level of these microorganisms will render the water not fit to bathe in, or even hazardous to the health. The health hazard relates partly to the possible presence of organisms that cause diseases, but is not only related to the amount of microorganisms present, but also to toxins that normal or harmless microorganisms may emit, for instance when they die or are killed off.

Chlorine has been traditionally used to disinfect water, and is effective against bacteria and viruses. However, due to health concerns regarding chlorine, there have been efforts to find other means of disinfection. For instance chlorine solutions used in public swimming pools are corrosive, and may further, if not correctly handled, lead to the formation of toxic chlorine gas, and must therefore be handled with great care. In order to avoid direct addition of chlorine to the water, different kinds of chlorine generators, or salt generators, have been used. These allow addition of pure salt, NaCl, to the pool, which the generator will transform to free chlorine in the water. Thus, while the addition of pure chlorine has been avoided, chlorine remains the active disinfectant agent within this system, and thus the related health concerns still remain an issue. Regardless of the means for providing chlorine, 1-5 ppm free chlorine is normally available in the pool water.

As an alternative to chlorine, various compositions of bromine, such as bronopol, and silver containing compositions have been used. When bromine containing compositions are used, such as bronopol, a concentration of 2-6 ppm is available in the pool water. However, these also give rise to environmental and health related concerns. For instance silver containing compounds may be enriched or concentrated in the nature, does not have a proven effect on short term for swimming pool water, and does not have an effect on viruses. Furthermore silver, when entered into the body, will accumulate in all organs, and is for instance carcinogenic.

Regardless of which disinfectant is being used of the above, or any other disinfecting agent that may be used today by the skilled person, but not explicitly mentioned above, they do not kill off algae in the water. Therefore, didecyldimethylammonium chloride (DDAC) is commonly used in addition to the agents above, to manage algae in the water, when necessary. Alternatives to DDAC are for instance alkylbenzyldimethyl ammonium chloride, poly-quarternary ammonium compounds, a polymer of N-methyl-metanamin and chloromethyl(oxiran), and polyhexamethylene biguanide.

### SUMMARY OF THE INVENTION

There is hence a need to find ways of disinfecting water in swimming pools and other recreational water systems that are more environmentally safe, less health hazardous, and that minimizes the number and amount of chemicals used to manage the microbial quality of the water.

The present invention attains to solve the problem of finding better ways of disinfecting pool water, that are less hazardous to both the environment and to health. Thus, the present invention provides for a composition for disinfecting water in pools or recreational water systems, containing DDAC as a single effective disinfecting agent, and a solvent, such as 2-propanol, with a balance of water, wherein the concentration of DDAC is about 0.2-1.3 weight %, preferably about 0.8-1.2 weight %.

Additionally, the present invention provides for the use of didecyldimethylammonium chloride (DDAC) as a single disinfectant for disinfecting water in pools or recreational water systems. Furthermore, a method for disinfection of water in pools or recreational water systems is provided, wherein the composition of above is added to the water such that the effective amount of DDAC in the water is about 0.02-0.13 ppm, preferably about 0.08-0.12 ppm.

### DEFINITIONS

By pool water is meant water in swimming pools, Jacuzzis, bubble pools, or any other recreational water systems in which humans bathe for recreational purposes. It relates to all kinds of pools, from large public swimming pools, to smaller individual pools or hot tubs

### DETAILED DESCRIPTION

When didecyldimethylammonium chloride (DDAC) is used as algaecide, it is normally used in a composition at a concentration of 30-50%, of which 100-200 ml/10 m³ is added to the water. This is generally only done when signs of algae appear. At high concentrations, DDAC is corrosive, toxic, and environmentally hazardous and may inhibit reproduction. The effective concentration of DDAC in the pool water amounts to 50-100 ml of DDAC per 10 m³ of pool water, or 5-10 ppm of DDAC

DDAC is also used within the food production industry to disinfect equipment and tools. It is for instance used to disinfect egg shells, milking equipment and udders, but then at much lower concentrations as compared to the algae treatment above. DDAC is classified as a food grade disinfectant. This means that it will not contaminate food with any harmful material on coming in direct contact or lying nearby. Thus it can be said that food grade DDAC, at low concentrations, is deemed harmless for human beings to even ingest, and thus, it has an advantageous safety profile also for use in swimming pools and other recreational water systems.

DDAC can be easily acquired by purchase from commercial providers, for instance from Akzo Nobel under the name Arquad, or from Merck Millipore under the product ID 814364.

The inventor has found that DDAC alone is sufficient as the single effective agent in disinfecting water from all microorganisms, including bacteria, virus, amoebae, fungi and algae. There is therefore no need to add additional disinfectant agents such as chlorine based compositions, or chlorine treatments or chlorine generators, nor bromine or silver containing compounds.

Even black algae, which are notoriously difficult to remove once such algae appear in the water of a swimming pool, will be removed by the use of DDAC.

As mentioned above, it is well established to use DDAC as an algaecide, and then at a concentration of 5 ppm in the pool water. This is in addition to the other disinfectant agent that is used at a concentration of at least 1-3 ppm in the pool water. Thus, a total of 6-8 ppm active agent is present in the pool water when using the standard methods for disinfection used today.

In contrast thereto, the disinfection according to the present invention can be achieved at a very low concentration of DDAC in the water, as compared to how it has been previously used. A solution comprising 0.2-1.3% of DDAC is used. Preferably the concentration is 0.8-1.0%. Thus any hazardous side effects of the typically used concentrations of DDAC within swimming pool disinfection are avoided. In addition to the DDAC, the composition for use according to the present invention contains a solvent, such as 2-propanol, and a balance of water. The solvent is added only to make DDAC liquid and easier to dilute in water, and any solvent commonly used in combination with DDAC may be used. The relationship of solvent:DDAC is normally about 1:2, or preferably 0.4:1. The amount of the solvent is not crucial but should preferably not exceed the amount needed to render the DDAC liquid and manageable in an aqueous solution. Apart from the solvent, no additional chemical components are present in the composition. No additional disinfecting agents are added to the composition, or used for the method of disinfecting water according to the present invention. The composition is added with 10 ml per 1 m³ water to be disinfected.

According to the present invention, a method is also provided for disinfection of water in pools or recreational water systems, wherein didecyldimethylammonium chloride (DDAC) is added to the pool water. Furthermore, according to the present invention DDAC is added as the single disinfectant agent in said method. The effective concentration of DDAC in the pool water is 0.02-0.13 ml/m ³, which is equivalent to 0.02-0.13 ppm. This is far below what is commonly used as an effective concentration of DDAC for killing algae, and also far below what is commonly used as an effective concentration in any of the standard methods and compositions for disinfection, as indicated above.

By using DDAC for disinfecting and cleaning of pool water according to the above, an environmentally safe method is achieved, leaving out the environmentally hazardous chemicals usually used within the field, as well as using a significantly lower concentration than traditionally used. Thus the chemical footprint is decreased as less chemicals and a lower amount of chemicals are used, and health hazards are minimized.

1. A composition for disinfecting water in pools or recreational water systems, containing didecyldimethylammonium chloride (DDAC) as a single effective disinfecting agent, and a solvent, with a balance of water, wherein the concentration of DDAC is about 0.2-1.3 weight %.

2. The composition according to claim 1, wherein the solvent is 2-propanol.

3. (canceled)

4. A method for disinfection of water in pools or recreational water systems, wherein didecyldiniethylammonium chloride (DDAC) is added to the pool water or recreational water system as a single effective disinfecting agent, such that the effective amount of DDAC in the pool water or recreational water system is about 0.02-0.13 ppm.

5. The composition for disinfecting water in pools or recreational water systems as claimed in claim 1, wherein the concentration of DDAC is about 0.8-1.2 weight %.

6. The method for disinfection of water in pools or recreational water systems as claimed in claim 4, wherein the effective amount of DDAC in the pool water or recreational water system is about 0.08-0.12 ppm.
